(19) United States
(12) Patent Application Publication
(10) Pub. No.: US 2011/0041776 A1
(43) Pub. Date: Feb. 24, 2011

(54) Indicator Device for an Animal and Method of Indicating How an Animal Should be Approached

(76) Inventors: Emma Victoria Robinson, Leamington Spa (GB); Neale Alan Hickin, Leamington Spa (GB)

Correspondence Address: GORDON & JACOBSON, P.C., 60 LONG RIDGE ROAD, SUITE 407, STAMFORD, CT, 06902, US

(21) Appl. No.: 12/620,776

(22) Filed: Nov. 18, 2009

(30) Foreign Application Priority Data
Aug. 20, 2009 (GB) 0914584.8

(51) Int. Cl. A01K 15/02; A01K 29/00

(52) U.S. Cl. 119/712; 119/858

(57) ABSTRACT

An indicator device for an animal includes an indication region and an indication means disposed upon the indication region and arranged to visibly indicate to a person whether and how the person should approach the animal. The indicator device also includes fastening means for fastening the indicator device to the animal. A method of coordinating interaction between a person and an animal is also provided. An indicator system for a plurality of animals is also provided. The system includes at least first and second indicator devices. The method includes determining how the animal should be approached and fastening an indicator device to the animal.

### CROSS-REFERENCE TO RELATED APPLICATIONS

This application claims priority from Great Britain Patent Application No. 0914584.8, filed on Aug. 20, 2009.

### BACKGROUND OF THE INVENTION

1. Field of the Invention

The present invention relates to an indicator device for an animal and to a method of providing an indication of how an animal should be approached.

2. State of the Art

It is common to see canines on beaches and in parks, for example, but it can be very difficult to ascertain the canine's disposition or temperament, such as whether the canine has an injury, is particularly playful or whether the canine has an antisocial nature. An owner may also wish to be able to control how a canine or other animal is approached.

People, and in particular children, are often attracted to animals such as canines, despite the fact that it may not be suitable to do so or the fact that an owner would prefer that the animal was not approached. People often approach an animal in an inappropriate manner, which can lead to an adverse reaction by the animal. This can be very dangerous for children and adults alike. In addition, when training an animal, such as a canine, it is often preferred that the canine only interacts with the instructor.

### SUMMARY OF THE INVENTION

In accordance with the present invention there is provided a indicator device for an animal, the indicator device comprising an indication region and indication means disposed upon the indication region arranged to visibly indicate whether and how a person should approach the animal, the indicator device further comprising fastening means for fastening the indicator to the animal.

The indicator device thus enables person accompanying an animal to provide an indication of how an animal should be approached and to exercise some control over how the animal is approached. The indication means may be viewed by another person and provides that person with relevant information on whether and how the animal should be approached. This ensures that an animal is approached in an appropriate or desired manner, or is not approached by a person other than its owner or instructor.

In an embodiment, the indication means is arranged to visibly indicate the disposition of the animal. The indicator device thus serves to provide a visual indication of the disposition of an animal, such as a canine. In an embodiment, the indication means is arranged to visibly indicate how a person accompanying the animal wishes the animal to be approached. The indicator device thus enables a person accompanying an animal to provide a visual indication of how the person wishes the animal to be approached or whether the person does not wish the animal to be approached.

In an embodiment, the indication means comprises a color applied to the indication region. In an embodiment, the color is selected from a set of colors, with each color being representative of a different manner in which the animal should be approached.

In an embodiment, the indication region comprises a jacket, which is arranged to extend over a shoulder region of the animal. In an embodiment, the jacket may be further arranged to extend over a chest region of the animal. In an embodiment, the jacket is arranged to extend to a position just behind the front legs of the canine. The jacket thus only extends a short way across the animal's body and does not interfere with the normal movement or behaviour of the animal.

In an embodiment, the color is selected from a set of colors, with each color being representative of one of a different animal disposition and a different manner in which a person should approach the animal.

In an embodiment, a first color is representative of a first animal disposition and/or a first preference on how the animal is to be approached, for example a young animal undergoing training, an animal with an antisocial disposition, an animal having a disability, or an animal under the control of an inexperienced animal handler, for example. In this case, it may not be suitable to approach the animal and the person accompanying the animal may prefer the animal is not approached.

In an embodiment, a second color is representative of a second animal disposition and/or a second preference on how the animal is to be approached, for example an ill animal, an animal having an unpredictable nature, or an animal under the control of a nervous animal handler, for example. In this case, it is considered that the animal may react unfavourably to erratic movements or to the approach of other animals, in which case the person accompanying the animal may prefer a steady approach to the animal, for example.

In an embodiment, a third color is representative of a third animal disposition and/or a third preference on how the animal is to be approached, for example an animal with a stable disposition and which the person accompanying the animal is happy to be approached at ease.

In an embodiment, the color is selected from the colors red, amber and green, such that the color red is associated with the first animal disposition and/or the first preference on how the animal is to be approached;

the color amber is associated with the second animal disposition and/or the second preference on how the animal is to be approached; and,

the color green is associated with the third animal disposition and/or the third preference on how the animal is to be approached.

In an embodiment, the fastening means comprises a hook and loop type fastener.

In an embodiment, the indicator comprises first fastening means disposed at a first end of the indication region and second fastening means disposed at a second end of the indication region.

In an embodiment, the first fastening means is arranged to pass around a neck of the animal and the second fastening means is arranged to pass around a waist or girth of the animal.

In an embodiment, the indicator device further comprises a reflective or high visibility section to make the animal more conspicuous to other persons.

In an embodiment, the animal comprises a canine.

In accordance with a second aspect of the present invention there is provided a method of providing an indication of how an animal should be approached, the method comprising
determining how the animal should be approached; and,
fastening an indicator device to the animal;
   wherein the indication device is representative of how the animal should be approached.

The method enables a person accompanying an animal to provide an indication of how an animal should be approached, enabling the person to exercise some control over how the animal is approached.

In an embodiment, the step of determining how the animal should be approached comprises determining the disposition of the animal. In an embodiment, the step of determining how the animal should be approached comprises determining how a person accompanying the animal would like the animal to be approached.

The method enables a person to determine whether an animal should be approached and how an animal is to be approached.

In an embodiment, the disposition of the animal is selected from a group of pre-determined animal dispositions.

In an embodiment, each animal disposition of the pre-determined animal dispositions or manner in which a person accompanying the animal wishes the animal to be approached is associated with a particular indication means.

In accordance with a third aspect of the present invention, there is provided an indicator system for a plurality of animals, the system comprising at least first and second indicator devices as described above.

The system enables a person to determine how each of a plurality of animals wearing the indicator devices should be approached. The person may encounter a plurality of animals wearing the indicator devices at the same time or may encounter different animals of the plurality of animals at different times.

Embodiments of the present invention will now be described by way of an example only and with reference to the accompanying drawings.

### BRIEF DESCRIPTION OF THE DRAWINGS

FIG. 1 is a schematic illustration of an indicator device according to an embodiment of the present invention;

FIG. 2 is a flow chart illustrating the various stages associated with the method according to a second embodiment of the present invention; and

FIG. 3 is an illustration of an indicator system for a plurality of animals according to a third embodiment of the present invention during use.

### DETAILED DESCRIPTION OF THE PREFERRED EMBODIMENTS

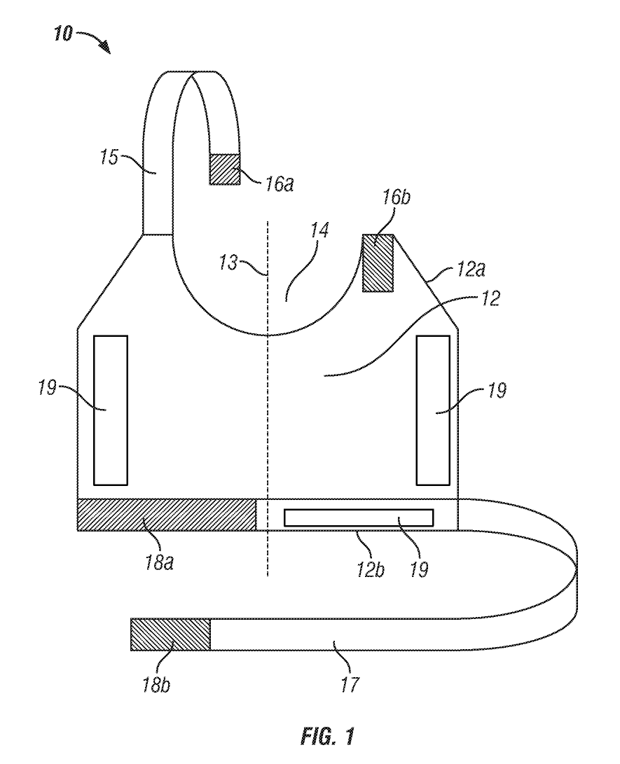

Referring to the FIG. 1 of the drawings there is illustrated an indicator device 10 which enables a person to determine whether an animal, such as a canine 11, for example, should be approached and/or how a canine 11 is to be approached, for example. The indicator device 10 comprises an indication region 12, indication means disposed on the indication region 12, and fastening means 15.

In this example, the indication region takes the form of a jacket 12 which is arranged to extend from the neck 11a of the canine 11 along the back 11b of the canine 11, to a position just behind the front legs 11c. In this manner, the jacket 12 is arranged to pass around the shoulders 11d and chest region 11e of the canine 11, for example. The jacket 12 is substantially symmetric about a central axis 13 thereof, which extends between a first 12a and second end 12b of the jacket 12. The first end 12a of the jacket 11 comprises a cut-away section 14, which is arranged to accommodate the neck of the canine when fitted thereon, and the second end 12b of the jacket is arranged to pass over the back of the canine.

The indicator device 10 further comprises fastening means in the form of a strap 15 which extends from one lateral side of jacket 12 at the first end 12a thereof, and is arranged to extend from the jacket 12 in a direction that is substantially parallel with the symmetric axis 13 of the jacket 12. A distal end of the strap 15 comprises a first section 16a of a hook and loop type fastening arrangement, which is arranged to engage and fasten with a second section 16b of a hook and loop type fastening arrangement. The skilled reader will recognise however, that other fastening means, such as buttons, buckles, laces (not shown) etc may also be used. The second section 16b of the hook and loop type fastening arrangement is elongate with respect to the first section 16a and disposed at the first end 12a of the jacket 12, at a position which is substantially symmetrically opposite the position on the jacket 12 from which the strap 15 extends. The elongate section 16b enables the first section 16a to engage with the second section 16b at various positions thereon to adjust the effective length of the strap 15 and thus accommodate various size canines 11.

In this example, the fastening means additionally comprises a further strap 17 which extends from one lateral side of jacket 12 at the second end 12b thereof, and is arranged to extend from the jacket 12 in a direction that is substantially transverse to the symmetric axis 13 of the jacket 12. A distal end of the strap 17 comprises a first section 18a of a hook and loop type fastening arrangement, which is arranged to engage and fasten with a second section 18b of a hook and loop type fastening arrangement. The skilled reader will again recognise however, that other fastening means, such as buttons, buckles, laces (not shown) etc may also be used. The second section 18b of the hook and loop type fastening arrangement extends along the second end 12b of the jacket 12 from a position that is substantially symmetrically opposite the position on the jacket 12 from which the strap 17 extends, toward the position from which the strap 17 extends. The elongate section 18b enables the first section 18a to engage with the second section 18b at various positions thereon to adjust the effective length of the strap 17 and thus accommodate various size canines 11.

The indicator device 10 may further comprise a plurality of reflective or high visibility strips 19 disposed on the jacket 12 and/or straps 15, 17 to make the canine 11 more conspicuous to other persons, such as other canine handlers 20.

In this example, the indication means comprises a color applied to the jacket 12. The color of the jacket 12 is selected from a set of three colors, for example red, amber and green (however, other colors and/or further colors may also be used), in which each color is representative of a different manner in which the canine should be approached. This may be according to temperament or disposition of the canine 11, so that people can make an informed decision on whether to approach the canine 11 and/or how the canine 11 is to be approached. The colors also enable a person accompanying the canine 11 to indicate whether the animal should be approached and/or their preference on how the animal should be approached.

For example, the color red is chosen to represent a canine disposition that may be characteristic of a young canine undergoing a training exercise, an anti-social canine, a canine having a disability, or a canine under the control of an inexperienced handler, for example; the color amber is chosen to represent a canine having an unpredictable nature or which may be ill (and thus feel threatened upon being approached by an unfamiliar person) or an animal under the control of a nervous animal handler, for example; the color green is chosen to represent a canine having a generally stable temperament.

Accordingly, a red jacket 12 is intended to indicate that a canine 11 should not be approached, or that a handler of the canine would prefer that the canine was not approached, for example; an amber jacket 12 is intended to indicate that a canine 11 should be approached with caution and as such, the handler may prefer the canine to only be approached by adults, for example; and, a green jacket 12 is intended to indicate that a canine 11 is generally safe to approach, while maintaining the normal levels of awareness, or that the canine handler is happy for the canine 11 to be approached.

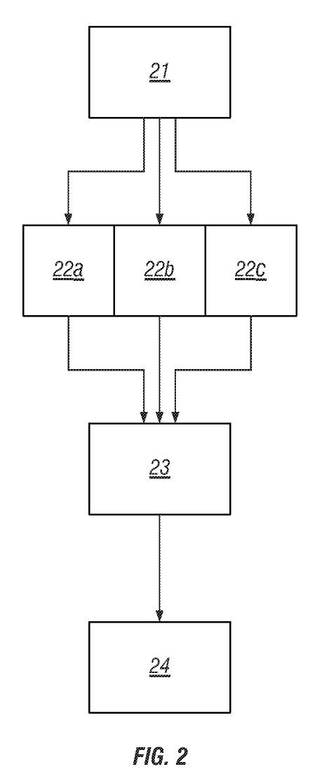

Referring to FIG. 2 of the drawings there is illustrated a sequence of steps of a method of providing an indication of whether a canine 11 should be approached and/or how a canine 11 is to be approached, according to an embodiment of the present invention. The canine 11 is first monitored at step 21 to determine the disposition of the canine 11 and thus the category 22 of disposition categories 22a-c (namely red 22a, amber 22b or green 22c, as described above) to which the canine 11 belongs. Alternatively, the handler (not shown) of the canine 11 may select a particular color 22a-c in accordance with their preference on whether the canine 11 should be approached or how the canine 11 is to be approached. Once the disposition category 22 of the canine 11 has been determined at step 23, the indicator 10 having the appropriate jacket 12 color is placed upon the shoulders 11d of the canine 11 (step 24). The first end 12a of the jacket 12 is wrapped around the canines neck 11a so that the hook fastening section 16a disposed at the distal end of the strap 15 can extend over the chest 11e of the canine 11 and engage with the loop fastening section 16b on the jacket 12. The strap 17 is then wrapped around the girth of the canine 11, just behind the front legs 11c of the canine 11, and the hook fastening section 18a disposed at the distal end of the strap 17 is fastened with the loop fastening section 18b on the jacket 12.

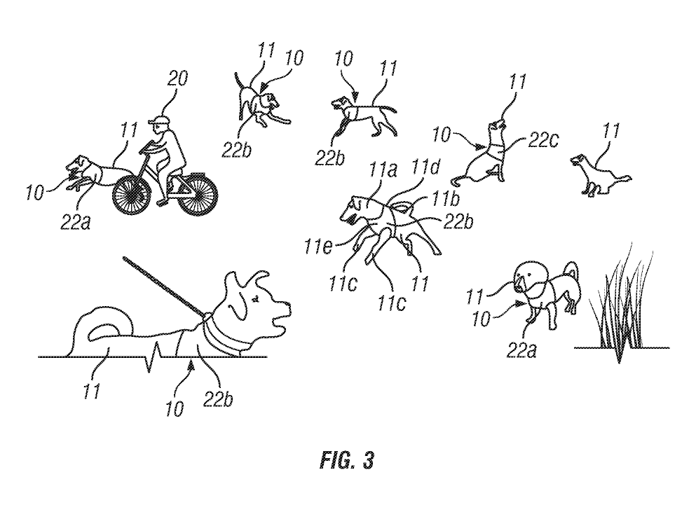

Referring to FIG. 3 of the drawings, there is illustrated an indicator system for a plurality of animals according to a third embodiment of the present invention. The system comprises a plurality of indictor devices 10 according to the first embodiment of the invention. It will be appreciated that the various indicator devices 10 will each be provided with a relevant colored jacket 12, reflective of how the respective canine 11 should be approached.

When walking a canine 11 in the park for example, the indicators 10 of the system and in particular, the color of the jackets 12 of each indicator 10, will provide other persons with information on whether or not they should approach the canine 11 or let children approach the canine 11, for example.

From the foregoing therefore, it is evident that the indicator device and system provides a simple yet effective means of indicating whether an animal such, as a canine, should be approached and/or how the animal, such as a canine, is to be approached.

What is claimed is:

1. An indicator device for an animal, comprising:
indication means disposed on an indication region defined by the indicator device, said indication means arranged to visibly indicate to a person whether and how the person should approach the animal; and
fastening means for fastening the indication means to the animal.

2. An indicator device according to claim 1, wherein:
the indication means visibly indicates to the person the disposition of the animal.

3. An indicator device according to claim 1, wherein:
the indication means visibly indicates to the person how an individual accompanying the animal wishes the animal to be approached.

4. An indicator device according to claim 1, wherein:
the indication means comprises a color applied to the indication region.

5. An indicator device according to claim 1, wherein:
the color is selected from a set of colors representative of at least one of a plurality of different animal dispositions and a plurality of different preferences on how the animal is to be approached.

6. An indicator device according to claim 5, wherein:
said set of colors includes a first color, a second color, and a third color, said first color representative of one of a first animal disposition and a first preference on how the animal is to be approached, said second color representative of one of a second animal disposition and a second preference on how the animal is to be approached, and
a third color representative of one of a third animal disposition and a third preference on how the animal is to be approached.

7. An indicator device according to claim 6, wherein:
the color is selected from the group consisting of red, amber and green, the color red is associated with one of the first animal disposition and the first preference on how the animal is to be approached, the color amber is associated with one of the second animal disposition and the second preference on how the animal is to be approached, and the color green is associated with one of the third animal disposition and the third preference on how the animal is to be approached.

8. An indicator device according to claim 1, wherein:
the indication region includes a jacket adapted to extend over a shoulder region of the animal.

9. An indicator device according to claim 8, wherein:
the animal is a canine, and the jacket is adapted to extend to a location just behind front legs of the canine.

10. An indicator device according to claim 1 further comprising:
first fastening means disposed at a first end of the indication region; and
second fastening means disposed at a second end of the indication region.

11. An indicator device according to claim 10, wherein:
the first fastening means is adapted to pass around a neck of the animal and the second fastening means is adapted to pass around a waist or girth of the animal.

12. An indicator device according to claim 1, further comprising:
a reflective or high visibility section for making the animal more conspicuous to at least one other person.

13. An indicator device according to claim 1, wherein:
the animal is a canine.

14. A method of coordinating interaction between a person and an animal, comprising:
determining how the animal should be approached by the person; and
fastening an indicator device to the animal,
wherein the indicator device is representative of how the animal should be approached by the person.

15. A method according to claim 14, wherein:
said determining how the animal should be approached by the person includes determining a disposition of the animal.

16. A method according to claim 14, wherein:
said determining how the animal should be approached by the person includes determining how an individual accompanying the animal would like the animal to be approached.

17. A method according to claim 15, wherein:
the disposition of the animal is selected from a plurality of pre-determined animal dispositions.

18. A method according to claim 17, wherein:
each animal disposition of the plurality of pre-determined animal dispositions or each manner in which an individual accompanying the animal wishes the animal to be approached corresponds to a particular indication means of said indicator device.

19. An indicator system for a plurality of animals, comprising:
a plurality of indicator devices, each according to claim 1.

20. An indicator device according to claim 1, wherein:
said indication region is part of an article secured to the animal.
